(19) United States
(12) Patent Application Publication
(10) Pub. No.: US 2010/0332733 A1
(43) Pub. Date: Dec. 30, 2010

(54) MATERIAL SERVER AND METHOD OF STORING MATERIAL

(76) Inventor: Toshio SUZUKI, Kanagawa-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/718,694

(22) Filed: Mar. 5, 2010

(30) Foreign Application Priority Data
Jun. 26, 2009 (JP) 2009-152334

(51) Int. Cl. G06F 12/02; G06F 12/00

(52) U.S. Cl. 711/103; 711/171; 711/E12.008; 711/E12.002

(57) ABSTRACT

According to one embodiment, a material server that includes a NAND flash memory which stores material that includes one or all of moving image data, audio data, and ANC data. A material ID detector detects a material ID in inputted material when such material is inputted into the material server. A block allocation unit in the material server allocates a block for storing the material each material ID. A plurality of buffers in the material server buffer the material each inputted material ID. A buffering data monitor in the material server monitors buffering data size in the buffers. A memory accessing unit in the material server writes buffered material to the NAND memory when a buffering data monitor detects that the buffering data size amounts to one page size.

### CROSS REFERENCE TO RELATED APPLICATION

This application is based upon and claims the benefit of priority from Japanese Patent Application No. 2009-152334,filed on Jun. 26, 2009, the entire contents of which are incorporated herein by reference.

### TECHNICAL FIELD

Disclosure generally relates to reading and writing in a material server.

### BACKGROUND

A material server for a broadcasting system stores data that contain moving image, still image, audio, and captions. The material server outputs data of stored material to an external device in order to broadcast such data according to a specified broadcasting time. A multitude of storing medium can be used for the material server, for example a HDD (Hard Disk Drive), a semiconductor memory, and any form of memory able to store material. Material of plural high bit rate materials corresponding to plural channels input into the material server. The material server is capable of outputting and inputting data of plural material. Therefore, the storing medium used for the material server is required to high-speed writing and high-speed reading. In recent years, material servers using NAND flash memory (a NAND-type flash memory, a NAND-type semiconductor memory) has been used.

NAND flash memory cannot write/read each bite unit due to the design characteristic of the NAND-type semiconductor memory. The characteristic is related to the write/read unit of the NAND flash memory. NAND flash memory utilizes a unit called “page” is write/read data. One page includes a plurality of bites. NAND flash memory must delete each set of data in a unit called a “block”. One block unit includes a plurality of pages. Due to the above characteristics, NAND flash memory has three basic processes which “page writing”, “page reading”, and “page deleting”.

Basic processing for NAND flash memory is different from basic processing for storing data, such as HDD. Therefore, when a conventional storing medium, such as a HDD, in the material server is replaced by NAND flash memory, the material sever cannot use high-speed write/read to send/receive data to/from the NAND flash memory.

For instance, it is assumed that material is written to the NAND flash memory, and then such the material is deleted from the NAND flash memory. In this case, only the page where the target material is stored is deleted from the block. This deletion causes the remaining material on the NAND flash memory to be fragmented. As a result, the material server using the NAND flash memory has disadvantages due to such fragmentation, such that defragmentation is required.

In addition, an art for related to solve this disadvantage is known (refer to Japanese Patent disclosure 2007-280068).

As noted above, the NAND flash memory is writes/reads each page unit. Therefore input data is not written to the NAND flash memory until such inputted data amounts to one page size. Input data is temporarily buffered. When such buffered data amount to one page data size, the data is written to the NAND flash memory in order. As a result, a plurality of material is written to one block. FIG. 7 shows data written to the NAND flash memory.

An example Shown in FIG. 7, 0th data for Material A is written into page [0] in block [0]. After that, 0th data in Material B is written to page [1] of the block [0]. Material A is required to be read continuously because the material includes moving image data and audio data. Therefore, the material server reads Material A in a manner that allows Material A to be presented continuously. For instance, when Material A is read out, the material server accesses the NAND flash memory in the order indicated by arrows in FIG. 7. Consequently, the material is read in each block in a fragmented state, and the material is further read from multiple and separate blocks. As a result, NAND flash memory struggles to be reach a high read output speed of the necessary data.

### SUMMARY

One aspect of this invention is to provide a material server that includes a NAND flash memory which stores material, that includes one or all of moving image data, audio data, and ANC data, a material ID detector that detects a material ID in inputted material, a block allocation unit that allocates a block for storing the material each material ID, a plurality of buffers that buffer the material each inputted material ID, a buffering data monitor that monitors buffering data size in the buffers, and a memory accessing unit that writes buffered material to the NAND memory when a buffering data monitor detects that the buffering data size amounts to one page size.

### BRIEF DESCRIPTION OF THE DRAWINGS

FIG. 1 is a diagram showing composition of a material server concerning the embodiment;

FIG. 2 is a diagram showing a main controller 16 shown in FIG. 1;

FIG. 3 is a diagram showing a memory controller 15 shown in FIG. 1;

FIG. 4 is a diagram showing an embodiment of input material;

FIG. 5 is a flowchart showing an example of a write procedure by memory controller 15;

FIG. 6 is a diagram showing an embodiment of a write/read by material server; and

FIG. 7 is a diagram showing a write/read by a conventional material server.

### BRIEF DESCRIPTION

A material server and method of storing material in the embodiment to provide a high speed write/read material recording.

Hereinafter, an embodiment of the present invention will be explained with reference to the drawings.

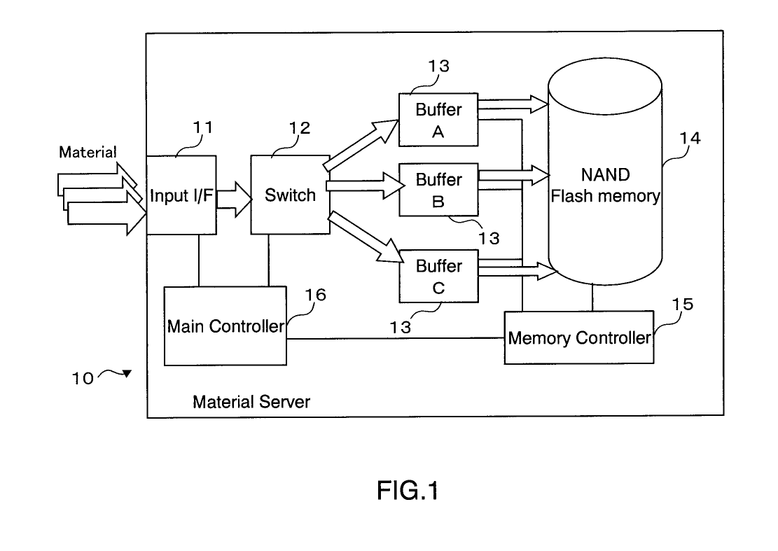

FIG. 1 is a diagram showing the composition of a Material Server concerning an embodiment. A Material Server comprises of an Input Interface 11, a Switch 12, a Buffer A13, a Buffer B13, a Buffer C13, a NAND Flash Memory 14, a Memory Controller 15, and a Main Controller 16. Input interface 11 receives a plurality of materials in parallel from an external device. The Switch 12 divides a plurality of input material into individual material. Buffer A13, Buffer B13, and Buffer C13 (collectively or independently “Buffers”) store material sorted by the Switch 12. The NAND Flash Memory 14 stores the sorted material temporary. The Memory Controller 15 controls writing and reading to NAND Flash Memory 14 by controlling the Buffers and NAND Flash Memory 14. The Main Controller 16 controls each unit in the material server such as Input Interface 11, Switch 12, and Memory Controller 15. Though the example shown herein includes three buffers, the number of the buffers is not limited to three. The number of the buffers is determined according to the number of input materials in parallel, such parallelism of the input material does not limit installation parameters the buffers, allowing the installation of such buffers to be parallel or otherwise.

The Material Server 10 may comprise of an output interface, an output buffer, an encoder, and a decoder.

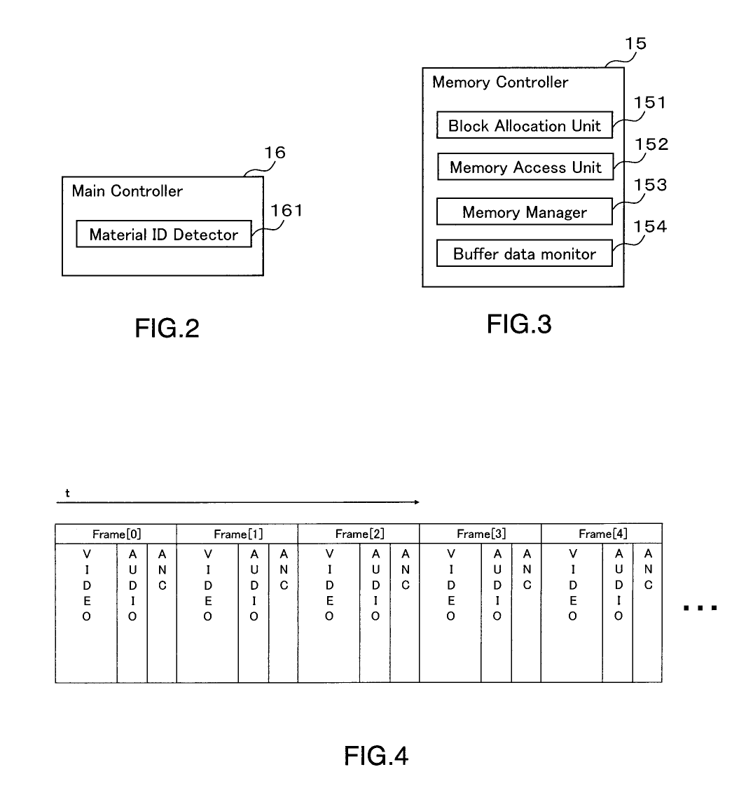

FIG. 2 is a diagram showing the Main Controller 16 shown in FIG. 1. The Main Controller 16 includes Material ID(Material Identification) Detector 161. Input material includes a header for detection of a Material ID. The Material ID Detector 161 detects materials by referring to the detected header. When materials such as multiplexed materials are the inputted into Material Server 10, Material ID Detector 161 detects the specific material by referring to the Material ID in the header. Switch 12 sorts the materials using the information it receives which has been detected by the Material ID Detector 16 each material. All sorted material is sent to the Buffers for buffering until further instructions are received by the Buffers.

When two or more materials are simultaneously inputted, one (for example, Material A) of the input plural materials completes inputting, another material (for example, Material B) begins to input. The Material ID Detector 16 interprets the input material from changing between materials by referring the header. After the input material has changed, Material B is buffered in Buffer 13 where the material A had been buffered.

FIG. 3 is a diagram showing Memory Controller 15 shown in FIG. 1. Memory Controller 15 includes Block Allocation Unit 151, Memory Accessing Unit 152, Memory Manager 153, and Buffering Data Monitor 154. The Block Allocation Unit 151 allocates the block to each material. The each material will be written to the block allocated by the Block Allocation Unit 151. The Memory Accessing Unit 152 accesses the NAND Flash Memory 14 for writing/reading/deleting. Memory Manager 153 stores and/or renews the physical address of written material, and the information of which block are allocated by the Block Accessing Unit 151 for each material. The Buffering Data Monitor 154 monitors the size of buffered data in the Buffers. Memory Controller 15 accesses the Buffers and NAND Flash Memory 14.

When Material ID Detector 161 detects the Material ID of inputted material, Block Allocation Unit 151 allocates a block in NAND Flash Memory 14 in order to write the specific material triggered by detection of the Material ID. Information of the block allocation is stored in Memory Manager 153. The materials sorted by the Switch 12 are buffered to a buffer (for example, Buffer A13). Buffer Data Monitor 154 monitors the data size buffered for Buffer 13, and detects when such data amounts to one page size. When the Buffering Data Monitor 154 detects that the data amounts to one page size, the Memory Accessing Unit 152 writes the buffered data to the block allocated to the material by Block Allocation Unit 151. In the case of reading the material, Memory Accessing Unit 152 interprets the physical address of the written material by referring to Memory Manager 153, and reads the material based on the physical address retrieved from Memory Manager 153.

FIG. 4 is a diagram showing an embodiment of input material.

The material has the structure of consecutive frames such as 30 frames per second. The frame has mainly three data entries: “VIDEO” for moving image, “AUDIO” for audio data, and “ANC” for data other than moving image and audio data such as caption or timing data. Each frame has each area of VIDEO, AUDIO, and ANC. The frames are arranged in order for play back. In FIG. 4, when time t progresses to the right, the material is played back in their predetermined order such as Frame [0], Frame [1], Frame [2], . . . Additional frames follow Frame [4] though five Frames from Frame [0] to Frame [4] as shown in FIG. 4.

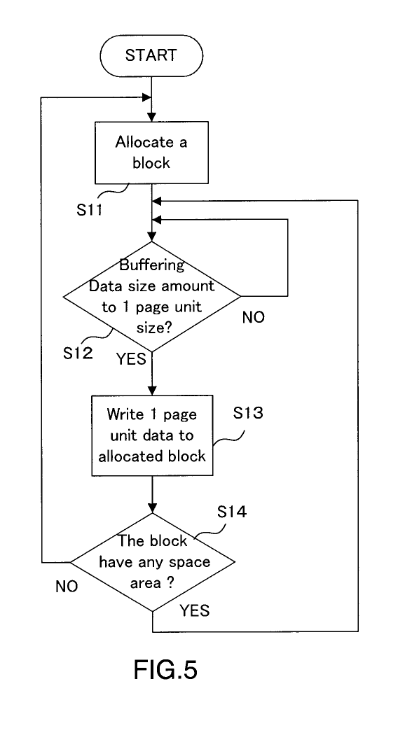

An example of a writing procedure to NAND Flash Memory 14 by mainly the Memory Controller 15 will be explained with reference to the FIG. 5.

FIG. 5 is a flowchart showing an example of a writing procedure by the Memory Controller 15.

A material (for example, Material A) is inputted into Input Interface 11. Material ID Detector 161 in Main Controller 16 detects the Material ID of the Material A. When Material ID Detector 161 detects the specific Material ID of the Material A, Block Allocation Unit 151 in Memory Controller 15 allocates a block (for example, Block [0]) among available blocks in the NAND Flash Memory 14 in order to write the material (S11). Inputted Material A is subsequently sent into the Switch 12. For instance, input Material A is sorted into the Buffer A13. When Material A is sorted by the Switch 12, Buffering Data Monitor 154 monitors the size of buffered data (S12). If Buffering Data Monitor 154 interprets that the size of the buffered data is less than one page size (NO at S12), the Buffering Data Monitor 154 continues monitoring date size until buffered data size amounts to one page size.

If Buffer Data Monitor 154 detects that the data amounts to one page size (YES at S12), the Memory Accessing Unit 152 writes to the allocated Block [0] at S11 each page unit (S13). After writing each page unit, Block Allocation Unit 151 interprets whether the Block [0] has unutilized space (S14). If Block [0] has no unutilized space (NO at S14), Block Allocation Unit 151 allocates another block at S11. For instance, Block Allocation Unit 151 allocates Block [n]. After allocation of Block [n], similar processing is repeated. If Block [0] has unutilized space (YES at S14), Buffering Data Monitor 154 monitors buffering data size at S12. After that, similar processing is repeated.

Memory Controller 15 processes each material shown in FIG. 5. In other words, when Materials A, B, and C are input in parallel, Memory Controller 15 processes Materials A, B, and C in parallel.

As mentioned above, when material A is input into the Input Interface 11, detection of input Material A by the Material ID Detector 161 functions as a trigger to start processing shown in FIG. 5. Similarly, when the material input from the Input Interface 11 changes from Material A into Material D (Material D inputted after material A), detection of changing Material ID by the Material ID Detector 161 functions as a trigger to start processing shown in FIG. 5.

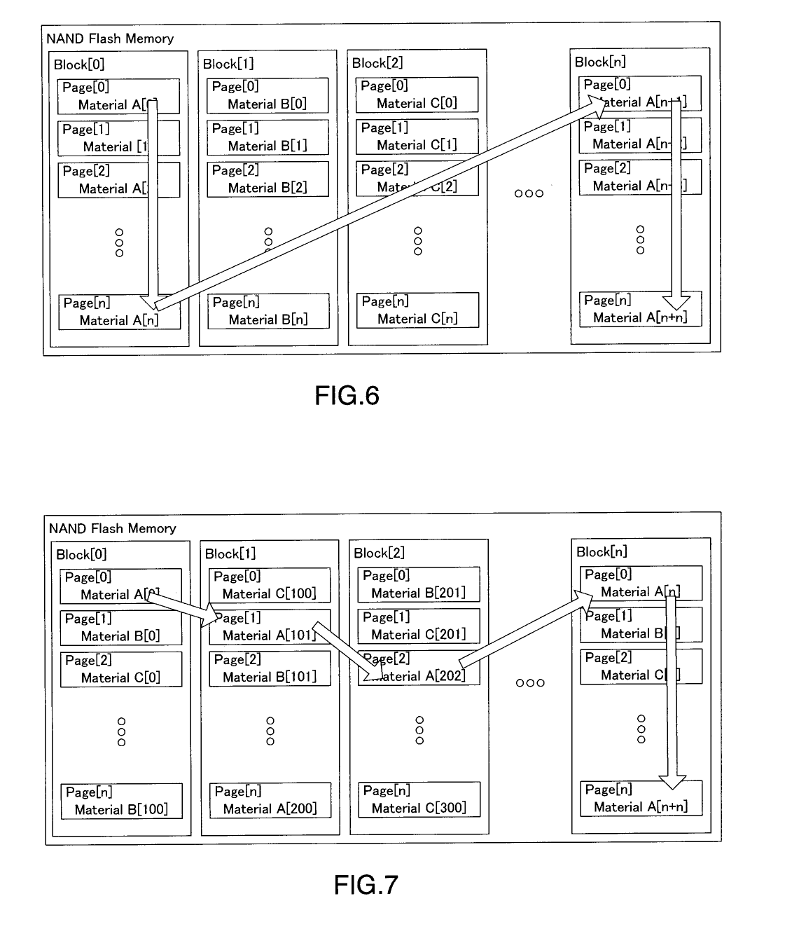

FIG. 6 is a diagram showing an embodiment of a result from a write/read in the NAND flash memory by the material server.

The NAND flash memory is divided into block of n+1 pieces from block [0] to block [n]. Each block is divided into plural pages (n+1 pages in FIG. 5). The figure in square parenthesis that is hereinafter described next to Material ID in pages shows order of data in the material.

The data of divided Material A into each page is stored in the Block [0]. First data in the Material A is stored in the Page [0] of Block [0]. Second data in the Material A is stored in the Page [1] of Block [0]. The data of Material A is sequentially stored on the page following Page [1] of Block [0] in order. The Material B is stored in Block [1] in order. The Material C is stored in the Block [2] in order. The data of n+1 pieces from n+2 data to 2n+3 (=n+2+n+1) data in the Material A is stored in Block [n] in order. The data of n+1 pieces from n+2 th data to 2n+3 data in the material A is the continuation data of the Material A filled up into the Block [0].

The material is stored in read out order which is so-called sequentially. Thereby, in the case of reading out the material, reading time is reduced because the material is sequentially read from the head of the block. In the case of writing each material, writing time is reduced because the material is sequentially written. Furthermore, write speed is faster because the material is written in parallel.

In the embodiment as shown in FIG. 1, plural material is input into one input interface in parallel such as multiplexed, and the switch sorts material into buffers. However, the material server may include an input interface of the number corresponding to the number of input materials, and the buffer of the number corresponding to each input interface.

Though an example of three input materials in parallel is shown in embodiment, the number of the input material into the material server is not limited to three, nor is it limited to a parallel configuration.

Other embodiments or modifications of the present invention will be apparent to those skilled in the art from consideration of the specification and practice of the invention disclosed herein. It is intended that the specification and example embodiments be considered as exemplary only, with a true scope and spirit of the invention being indicated by the following.

What is claimed is:

1. A material server, comprising:
a NAND flash memory for storing material including at least one of moving image data and audio data;
a material ID detector detecting a material ID in inputted material;
a block allocation unit allocating a block to each material being detected by the material ID detector in order to store the material each material ID;
a plurality of buffers buffering the material each inputted material ID;
a buffering data monitor monitoring buffering data size in the buffers; and
a memory accessing unit writing the buffered material to the NAND memory if buffered data size detected by the buffering data monitor amounts to one page size.

2. A method for storing material to a NAND flash memory, comprising:
detecting a material ID in inputted material;
allocating a block for storing to each material being detected in order to store the material each material ID;
monitoring buffered data size in buffers which buffer material each material ID; and
writing the buffered material in the buffers to the NAND memory if monitored buffer data size by amounts to one page size.
